(19) United States
(12) Patent Application Publication
(10) Pub. No.: US 2026/0187058 A1
(43) Pub. Date: Jul. 2, 2026

(54) Vector-Based AI Architecture for Reducing Hallucinations in Data-Driven Conversations through Targeted Classification and Parameter Extraction

(71) Applicant: Neil Sagar Pendyala, Palo Alto, CA (US)

(72) Inventor: Neil Sagar Pendyala, Palo Alto, CA (US)

(21) Appl. No.: 19/007,547

(22) Filed: Jan. 1, 2025

(51) Int. Cl. G06F 16/2452; G06F 16/22; G06F 16/28; G06N 20/00

(52) U.S. Cl. CPC G06F 16/2452; G06F 16/2237; G06F 16/285; G06N 20/00

(57) ABSTRACT

This invention addresses failures of probabilistic language models in computer-implemented conversational systems when answering questions over structured, deterministic datasets by preventing responses that rely on statistical inference rather than stored factual values. The system executes processor-based instructions operating on structured data represented as key-value pairs, where certain parameters correspond to authoritative factual attributes. User queries are mapped to relevant parameters using vector-based similarity, and response generation is constrained to a parameter-bounded scope derived from the structured data. Candidate responses are deterministically compared against expected parameter values, and responses that reference data outside the bounded scope or fail to include the expected value are suppressed or rejected. By enforcing response grounding to explicit structured data values rather than probabilistic priors, the invention prevents out-of-scope answers in data-sensitive applications such as healthcare, compliance, and enterprise record systems.

### BACKGROUND

AI-powered conversational systems are increasingly utilized in industries requiring precise and timely responses, such as healthcare and finance. These chatbots rely on sophisticated generative models to handle user queries, often in contexts demanding high accuracy. However, existing systems frequently face significant challenges, including hallucination of non-existent data, misinterpretation of user queries, and failure to validate responses against structured datasets.

In many applications, such as patient billing in healthcare or account reconciliation in finance, these inaccuracies can lead to substantial operational risks, including serving incorrect financial information, reduced trust, and potential legal liabilities. Conventional AI solutions attempt to address these challenges by enhancing semantic understanding or improving model fluency but fall short in systematically validating outputs against structured data.

Furthermore, existing systems lack robust mechanisms for precise query classification, which exacerbates the problem of aligning user intent with appropriate datasets. This gap often results in outputs that do not meet the stringent accuracy requirements of data-sensitive domains. These limitations underscore the need for a novel approach that integrates query classification with response validation to ensure the reliability of AI-generated outputs.

### SUMMARY

The present disclosure provides a system and method for enhancing the accuracy and reliability of AI-generated responses in data-sensitive applications. The invention is specifically designed to operate with structured data formatted as key-value pairs intended for conversational interactions. Each key (parameter) represents an attribute, such as “balance,” “name,” “patient ID,” or “insurance,” and is associated with a corresponding value, such as 50.00, “John Doe,” 12345, or “HealthPlan X,” respectively. This system enables precise question-answering directed at such datasets, significantly improving response accuracy by validating the inclusion of the correct parameter value and narrowing down the relevant data.

In an example embodiment, the system comprises at least one processor for executing machine-readable instructions and a memory storing instructions configured to cause the processor to perform operations. These operations include transforming structured key-value pair data into metadata-enriched vector representations, classifying user queries using vector similarity algorithms to identify intent, and aligning queries with the relevant structured data fields. For instance, in a dataset containing a patient's information, the system can classify a question like “What is the balance?” to specifically target the “balance” parameter and validate the response against its value, such as 50.00. The system isolates the relevant key-value pair, preventing unnecessary processing of the entire dataset.

The invention ensures precise query classification by utilizing metadata-enriched vector representations that map user queries to predefined namespaces, enabling accurate intent identification. Cross-referencing AI outputs with structured datasets validates correctness and ensures responses are aligned with user expectations. For example, in a large dataset related to a patient, the system narrows the query scope to a single relevant key-value pair, such as “balance: 50.00,” ensuring the AI response pertains specifically to the asked question.

This system is particularly advantageous for industries such as healthcare and finance, where datasets often consist of extensive key-value pairs associated with entities like patients or accounts. By combining metadata-rich query classification with response validation, the disclosed invention mitigates common challenges in AI-driven systems, such as hallucinations and misinterpretations, while improving operational efficiency and user trust.

In another example embodiment, the system dynamically adapts to various data-sensitive applications, ensuring seamless integration with existing AI models and structured datasets. This adaptability enables a broad range of use cases, including real-time financial reporting, healthcare query systems, and enterprise-level software integrations. By isolating the relevant key-value pair from a comprehensive dataset and iteratively validating AI responses, the invention ensures accuracy and trustworthiness in complex, data-sensitive environments.

### DESCRIPTION OF THE DRAWINGS

Some embodiments of the invention are illustrated in the accompanying drawings. These drawings provide a high-level summary of the invention's core components and processes, referencing key sections while showing how they interrelate.

FIG. 1 illustrates the process 100 of transforming structured data 110 into vector representations 130. Structured data parameters and their associated values are restructured into vectors for storage in the vector database.

FIG. 2 depicts the conversion process 200 for encoding relevant parameter information 210 into numerical vector encodings 230. This includes metadata, such as parameter descriptions and keywords, which are stored alongside the vectors.

FIG. 3 provides an overview 300 of the query-response workflow using a vector database 320. A user query 310 is processed and matched to the most relevant vector, enabling retrieval of structured data.

FIG. 4 demonstrates the integration 400 of structured data with an AI model. User queries 401 are contextualized with structured data parameters and validated through the AI model 416, ensuring responses align with expected values.

### DESCRIPTION

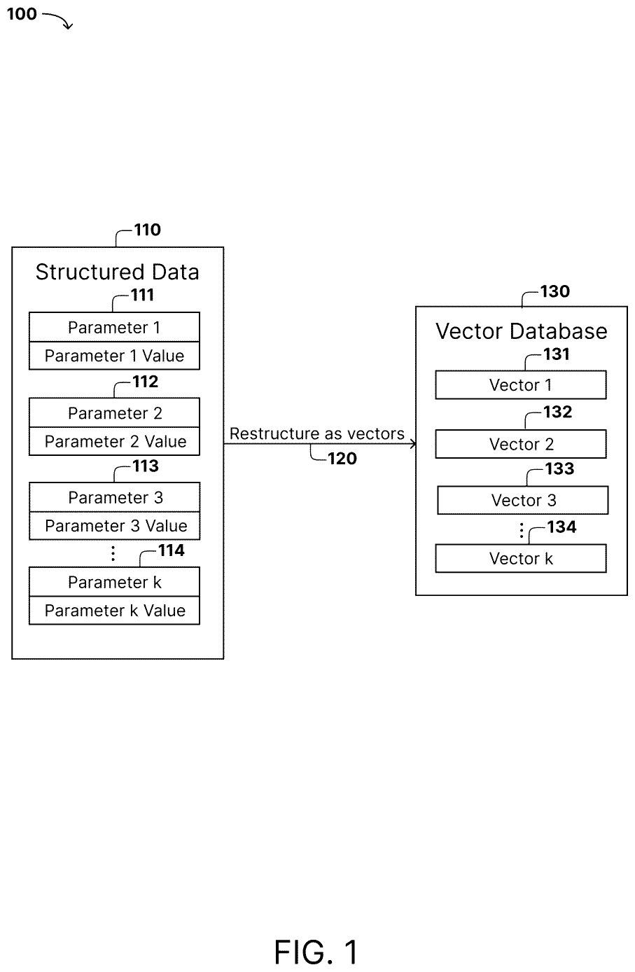

FIG. 1 depicts one embodiment of a structured data processing environment 100 in which the disclosed technology may be practiced. As depicted, the structured data processing environment 100 includes structured data 110 specifically designed for data-driven conversations involving key-value pairs. Each key-value pair consists of a parameter (the key) and its corresponding value. The parameters, such as parameter 1 111, parameter 2 112, parameter 3 113, and so on up to parameter k 114, are strings of English words that represent specific concepts or attributes. For example, a parameter may represent “balance,” with an associated value of 50.00. These key-value pairs are designed to support conversational queries. For instance, a user might ask, “What is the balance?” and the system would respond based on the parameter-value mappings.

The key-value pairs are restructured 120 into vector representations stored in a vector database 130. The resulting vectors—corresponding to vector 1 131, vector 2 132, vector 3 133, up to vector k 134—mirror the structure and length of the original key-value pairs in the structured data 110. This mirroring ensures that each parameter and its value in the structured data has a corresponding vector representation, enabling efficient and context-aware querying. This process allows the system to support natural language interactions by converting the structured data into a format optimized for rapid retrieval and contextual understanding in response to user queries.

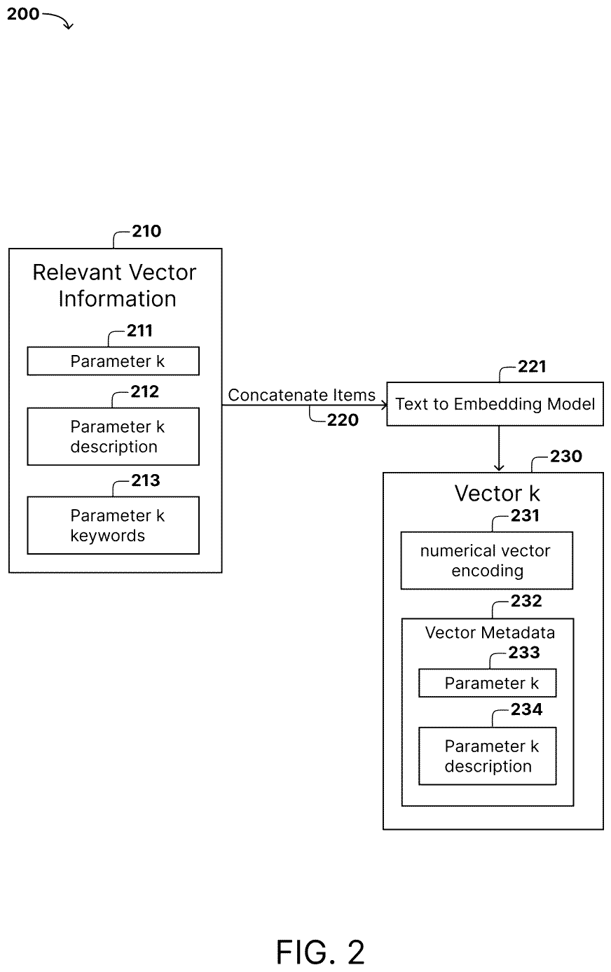

FIG. 2 illustrates one embodiment of the vector creation process 200, which is used in FIG. 1 for the restructuring step 120. This figure demonstrates the process for converting a single arbitrary parameter into its corresponding vector. As shown, the relevant vector information 210 for this process includes a parameter label 211, a parameter description 212, and associated keywords 213. It is important to note that for the parameter label 211, only the string representing the English word or phrase is used, and not the parameter value. For example, if the parameter were “balance,” only the string “balance” is taken, without including its corresponding value such as 50.00. The parameter description 212 and keywords 213 are manually generated by a human to provide a detailed understanding of the parameter's meaning. For instance, the description for “balance” might elaborate that it is “the amount of money owed for a service.” This manual generation ensures clarity and semantic richness, enabling the system to align user queries accurately with the intended context of the parameters.

To create the vector, the parameter label 211, parameter description 212, and parameter keywords 213 are concatenated together into a single input 220. This concatenated input is then run through a text-to-embedding model 221, which encodes the input into a numerical vector encoding 231. The numerical vector encoding 231 captures the semantic meaning of the combined components. The overall vector k 230 is then created by using the numerical vector encoding 231 as the vector and appending the metadata 232, which includes contextual information such as the parameter label 233 (same as 211) and the parameter description 234 (same as 212). This step ensures that the final representation in the vector database includes both the numerical vector encoding and the accompanying metadata for a holistic representation of the parameter's identity and context.

This process is repeated for each parameter in the structured data 110 from FIG. 1, converting parameters 1 through k into their respective vectors (e.g., vectors 131, 132, 133, . . . 134). FIG. 2 represents a single instance of this process, while in FIG. 1, the same process is applied iteratively to create the complete set of vectors stored in the vector database 130.

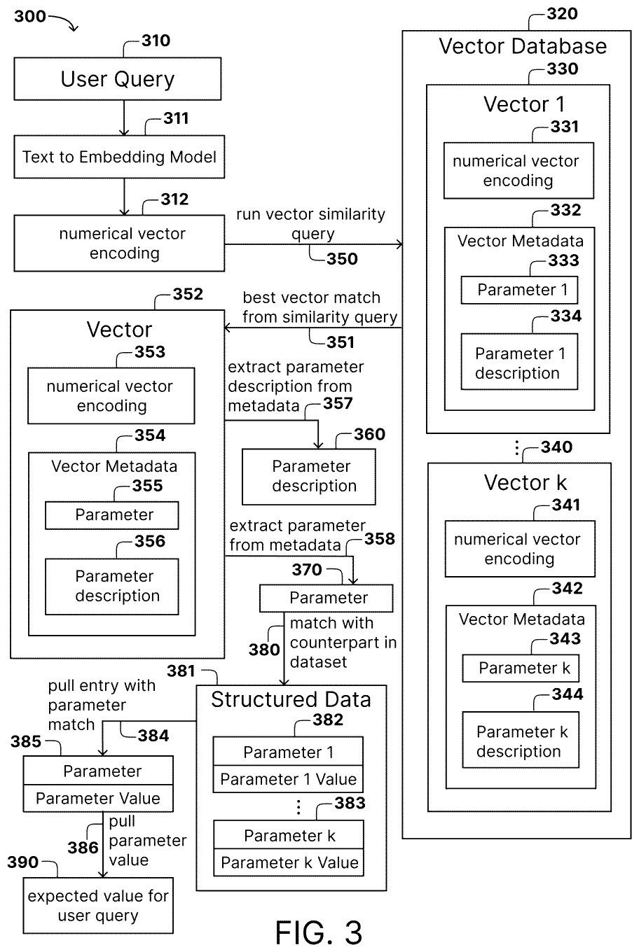

FIG. 3 depicts one embodiment of a query-response workflow 300 using a vector database 320. As depicted, a user query 310 is fed into a text-to-embedding model 311 and transformed into a numerical vector encoding 312, which is then matched against the stored vectors in the vector database 320 through a similarity query 350. This similarity query is performed exclusively between the numerical vector encoding 312 of the user query and the numerical vector encodings of each stored vector (e.g., 331 or 341). The metadata associated with each vector, such as parameter labels and descriptions, is not used in the similarity query. This ensures that the similarity calculation is purely numerical, focusing solely on the vector representations to determine the closest match.

Within the vector database 320, the sections labeled as vector 1 330 and vector k 340 represent an arbitrary number of vectors, from 1 to k. This is visually denoted by the three dotted lines between the 330 and 340 boxes, indicating the presence of additional vectors between the first and the last. This design allows the database to accommodate any number of vectors, ensuring scalability and flexibility for datasets of varying sizes.

Once the closest matching vector 352 is found through the similarity query 351, it and its associated metadata 354 are retrieved. This metadata includes the parameter 355 and its associated description 356. Using this metadata, the system identifies the parameter description 357 and extracts it from the metadata 360. The parameter label is also extracted from the metadata 358, allowing the system to determine the parameter associated with the user query 370. This associated parameter is matched with its counterpart 380 in the original structured dataset 381, also represented as 110 in the structured data environment 100 from FIG. 1. The original structured dataset 381 contains all parameters listed from parameter 1 382 to parameter k 383, again representing 1 to some arbitrary k. Once the system establishes a match, it pulls the relevant entry with a parameter match 384 to locate the specific entry in the structured data relevant to the query 385. This entry represents the key-value pair associated with the query. The system can then extract the value of the parameter 386, providing the expected value 390 that answers the user's question related to that parameter. With all these steps, the system enables the handling of a question 310 by determining the associated parameter from the structured dataset 381, the description of said parameter 360 to provide context about its meaning, and the expected value for the specific parameter in relation to the question 390.

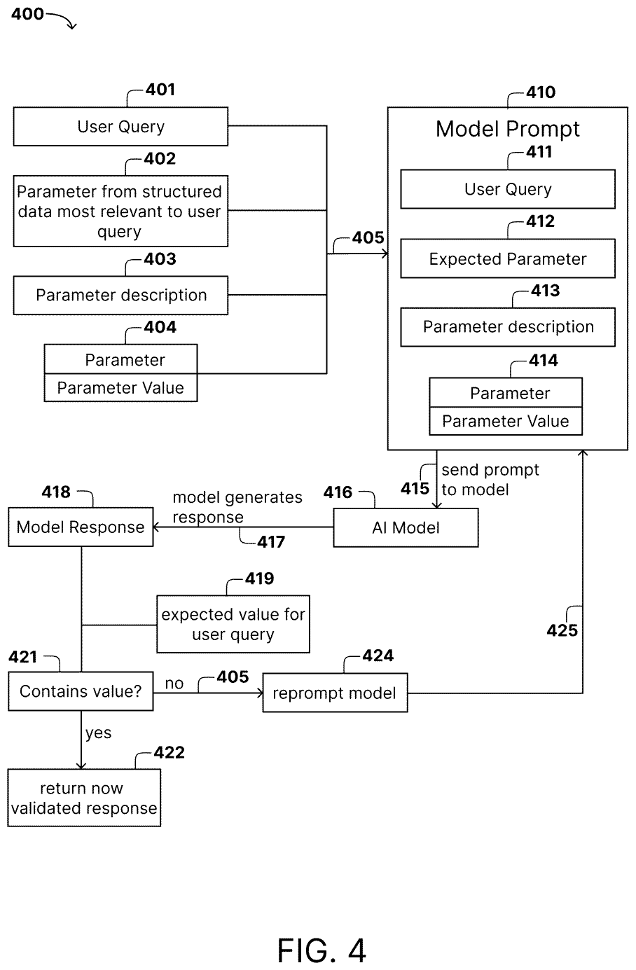

FIG. 4 illustrates one embodiment of a system 400 configured to validate responses generated by an AI model 416. The system processes user queries 401, which correspond to the user queries 310 described in FIG. 3. The user query 401 is associated with a parameter from the structured data most relevant to the query 402, corresponding to parameter 370 in FIG. 3. The parameter description 403, which provides the contextual meaning for the parameter, is consistent with the description 360 from FIG. 3. Additionally, the data entry represented by the parameter and its associated value as a key-value pair 404 aligns with the entry identified as 385 in FIG. 3, ensuring continuity and consistency across the system.

The system 400 incorporates these elements into a model prompt 410 that includes the user query 411, the expected parameter 412, the parameter description 413, and the parameter value 414. The model prompt explicitly instructs the AI model to generate a response 417 based on the provided key-value pair data. It clarifies that the query pertains to the expected parameter 412 and that the parameter is defined by the description 413. For example, if the parameter is “balance,” the description 413 may specify that it refers to “the amount of money owed for a service.” This approach ensures the AI model has clear context about the query and its relation to the structured data.

The iterative loop within the system ensures that any response not containing the expected value 421, 405 will not be marked as satisfactory. The model is re-prompted 424 with the same prompt 425 until it generates a response that includes the expected value 419. Once a response is produced that meets this criterion, it is validated as accurate 422. This loop ensures invalid responses with incorrect values are systematically excluded. In data-sensitive applications, such as healthcare and banking, where precision and accuracy are critical, this mechanism is particularly valuable, providing a robust solution for delivering reliable, validated responses in contexts where errors could have significant consequences.

This system directly addresses the problem of AI models hallucinating false values in data-driven conversations. By cross-referencing the model's output with the expected value 419, derived from the structured data and corresponding to value 390 in FIG. 3, the system ensures the response explicitly contains the expected value. Additionally, since the model prompt 410 includes the expected parameter 412 and its respective description 413, the AI model 416 gains significantly more context about the query compared to simply sending the user query 411 and a data entry 414. This richer context reduces ambiguity and enhances the model's understanding of the query.

The system further improves reliability by filtering the dataset to isolate only the relevant parameter before passing it to the model. Instead of requiring the AI model to process the entire structured dataset 110 from FIG. 1 environment 100, it operates on a subset narrowed to the relevant parameter. This reduces the amount of data the model must process, significantly lowering the chances of mistakenly including incorrect entries in its response or misinterpreting the question. By combining precise contextual input with a reduced dataset scope, the system both enhances the relevance of the data provided to the model and minimizes potential errors.

1-15. (canceled)

16. A system for constraining AI-generated responses in data-driven conversations, the system comprising: at least one processor; non-transitory memory storing instructions that, when executed by the processor, cause the processor to:
(a) store a structured dataset comprising key-value pairs, wherein at least a subset of keys correspond to deterministic factual attributes representing authoritative states stored in a record system;
(b) transform the keys of the structured dataset into vector representations and store the vector representations in a vector database;
(c) receive a user query and generate a query vector encoding;
(d) identify, using vector-based similarity between the query vector encoding and the vector representations, a parameter corresponding to the user query;
(e) retrieve, from the structured dataset, an expected value associated with the identified parameter; and
(f) in addition to identifying the parameter, execute a veristat, comprising a deterministic response-enforcement routine implemented as processor-executed instructions to:
(i) generate a model prompt constrained to the identified parameter and the expected value;
(ii) invoke an artificial intelligence model to generate a candidate response;
(iii) perform a deterministic comparison between the candidate response and the expected value retrieved from the structured dataset; and
(iv) suppress, discard, or withhold output of the candidate response when the candidate response does not explicitly include the expected value or references information outside a parameter-bounded scope,
whereby, for the deterministic factual attributes, the processor suppresses candidate responses that do not satisfy the deterministic comparison between the candidate response and the expected value, thereby constraining AI-generated responses to authoritative structured data values.

17. The system of claim 16, wherein the veristat iteratively re-invokes the artificial intelligence model until the candidate response explicitly includes the expected value or a termination condition is reached.

18. A method for constraining AI-generated responses in data-driven conversations, the method comprising: transforming structured data stored as key-value pairs into vector representations; receiving a user query and generating a query vector encoding; identifying, using vector-based similarity, a parameter corresponding to the user query; retrieving an expected value associated with the parameter from the structured data; generating a model prompt constrained to the parameter and the expected value; invoking an artificial intelligence model to generate a candidate response; deterministically comparing the candidate response to the expected value retrieved from the structured dataset; and suppressing or rejecting the candidate response when the candidate response does not explicitly include the expected value or references information outside a parameter-bounded scope.

19. The method of claim 18, wherein the parameter corresponds to a deterministic factual attribute and probabilistic inference is suppressed when generating the candidate response.
